(19) United States
(12) Patent Application Publication
(10) Pub. No.: US 2013/0318018 A1
(43) Pub. Date: Nov. 28, 2013

(54) NEURAL NETWORK-BASED TURBINE MONITORING SYSTEM

(71) Applicants: Prabhanjana Kalya, Greenville, SC (US); Trevor Valder Jones, Greenville, SC (US)

(72) Inventors: Prabhanjana Kalya, Greenville, SC (US); Trevor Valder Jones, Greenville, SC (US)

(73) Assignee: GENERAL ELECTRIC COMPANY, Schenectady, NY (US)

(21) Appl. No.: 13/478,967

(22) Filed: May 23, 2012

(51) Int. Cl. G06N 3/02

(52) U.S. Cl. 706/21

(57) ABSTRACT

A neural network-based system for monitoring a turbine compressor. In various embodiments, the neural network-based system includes: at least one computing device configured to monitor a turbine compressor by performing actions including: comparing a monitoring output from a first artificial neural network (ANN) about the turbine compressor to a monitoring output from a second, distinct ANN about the turbine compressor; and predicting a probability of a malfunction in the turbine compressor based upon the comparison of the monitoring outputs from the first ANN and the second, distinct ANN.

### BACKGROUND OF THE INVENTION

The subject matter disclosed herein relates to a monitoring system for a turbine. More particularly, aspects of the invention include a neural network-based monitoring system for a turbine compressor.

During the operational lifecycle of a gas turbine, the down time between shutdown and the next restart is limited by the differential expansion of the compressor rotor and the compressor casing. This differential expansion can be caused by differences in thermal gradients and material properties between the rotor and casing. Differential expansion can lead to interference between compressor rotor blades and the casing, which consequently, can lead to compressor failure and/or required unscheduled maintenance. This situation can be exacerbated by starts that are faster than normal, dubbed “Fast Start” technologies in the art.

The current approach for mitigating compressor rubs (e.g., contact between blades and casing) is to design the compressor with clearance tolerances such that differential expansion of the rotor and casing does not cause interference. However, these tolerances cause the compressor to run below its desired efficiency during steady-state operation.

### BRIEF DESCRIPTION OF THE INVENTION

Various embodiments of the invention include a neural network-based system for monitoring a turbine compressor. In some embodiments, the neural network-based system includes: at least one computing device configured to monitor a turbine compressor by performing actions including: comparing a monitoring output from a first artificial neural network (ANN) about the turbine compressor to a monitoring output from a second, distinct ANN about the turbine compressor; and predicting a probability of a malfunction in the turbine compressor based upon the comparison of the monitoring outputs from the first ANN and the second, distinct ANN.

A first aspect of the invention includes: a system having: at least one computing device configured to monitor a turbine compressor by performing actions including: comparing a monitoring output from a first artificial neural network (ANN) about the turbine compressor to a monitoring output from a second, distinct ANN about the turbine compressor; and predicting a probability of a malfunction in the turbine compressor based upon the comparison of the monitoring outputs from the first ANN and the second, distinct ANN.

A second aspect of the invention includes: a computer program having program code embodied in at least one computer-readable storage medium, which when executed, enables a computer system to monitor a turbine compressor by performing actions including: comparing a monitoring output from a first artificial neural network (ANN) about the turbine compressor to a monitoring output from a second, distinct ANN about the turbine compressor; and predicting a probability of a malfunction in the turbine compressor based upon the comparison of the monitoring outputs from the first ANN and the second, distinct ANN.

A third aspect of the invention includes: a system having: a control system for a turbine compressor; and at least one computing device operably connected to the control system, the at least one computing device configured to monitor the turbine compressor by performing actions including: comparing a monitoring output from a first artificial neural network (ANN) about the turbine compressor to a monitoring output from a second, distinct ANN about the turbine compressor; and predicting a probability of a malfunction in the turbine compressor based upon the comparison of the monitoring outputs from the first ANN and the second, distinct ANN.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a data flow diagram illustrating processes in forming an artificial neural network (ANN) according to embodiments of the invention.

FIG. 2 shows a data flow diagram illustrating processes in forming an artificial neural network (ANN) according to embodiments of the invention.

FIG. 3 shows a data flow diagram illustrating processes performed by a stochastic decision engine according to embodiments of the invention.

FIG. 4 shows an illustrative environment according to embodiments of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The subject matter disclosed herein relates to a monitoring system for a turbine. More particularly, aspects of the invention include a neural network-based monitoring system for a turbine compressor, e.g., a gas turbine compressor.

As noted herein, the current approach for mitigating compressor rubs is to design the compressor with clearance tolerances such that differential expansion of the rotor and casing does not cause interference. However, these tolerances cause the compressor to run below its desired efficiency during steady-state operation.

In contrast to this conventional approach, aspects of the invention provide for a system, a method and a related computer program product utilizing a neural network to monitor gas turbine operations for diagnosing one or more potential compressor rubs. More particularly, aspects of the invention include placing a set of temporary sensors (e.g., pressure transmitters, temperature sensors, strain gauges and proximity sensors) at strategic locations on the compressor. Additionally, aspects of the invention include utilizing a plurality of permanent sensors (e.g., pressure transmitters, vibration sensors and temperature sensors) at locations on the compressor.

In accordance with various embodiments of the invention, the temporary sensors gather nominal operation data about the compressor, and this nominal operation data is used to train two distinct artificial neural networks (ANNs). The first artificial neural network (ANN) is developed using a set of permanent and temporary sensors representing gas turbine state (using both permanent and temporary sensors) and gas turbine operating parameters (using permanent sensors) as model inputs. The output of the first ANN is a model of the temporary sensors, and this model can be used as real-time surrogates of the parameters indicating compressor rubs. A second ANN can be developed using only operating parameters of the gas turbine in order to model the nominal operation of the compressor. The first ANN will serve as the basis for determining anomalous behavior of the compressor. The second ANN will serve as the basis for determining nominal behavior of the compressor. After training both ANNs, the output from each of the two models can be stochastically compared to detect the type, severity, location and/or probability of an impending compressor failure.

As noted herein, in various embodiments of the invention, the first ANN is used to model nominal operation of the compressor in order to create a baseline, and the second ANN is developed to model real-time operation of the compressor. Outputs from the first ANN and the second ANN can be stochastically analyzed to predict a type, severity and/or location of an impending compressor failure. As noted herein, the compressor can be temporarily instrumented with sensors, including compressor casing thermocouples, compressor casing surface strain gauges, vibration sensors, compressor blade-to-casing proximity sensors, and/or inter-stage pressure dynamic sensors.

Initially, the first ANN can be developed using a set of permanent sensors representing gas turbine (GT) state and GT operating parameters as model inputs. The GT state can be represented using parameters determined by existing sensors such as compressor discharge temperature sensors, compressor discharge pressure sensors, vibration measurements, casing door/open detectors, firing temperature sensors, and exhaust temperature sensors. The GT operating parameters can be represented using existing sensors monitoring inlet guide vane position, inlet bleed heat valve position, extraction flow valve position, GT shaft speed and/or ambient conditions.

Next, the process can include training the first ANN using a plurality of temporary sensors on the compressor. The training process includes iteratively determining the weight matrix of the ANN such that the mean squared error (MSE) between the modeled output and the temporary sensor outputs is below a predetermined threshold (e.g., a minimal acceptable tolerance threshold). After training the first ANN, the output from the first ANN can be used as a model of the temporary sensors, which is used as a real-time surrogate of the parameters indicating compressor rub (where compressor rub can be considered anomalous behavior).

Following development of the first ANN, a second ANN can be developed with a similar architecture to the first ANN, with one difference being that the input to the second ANN relies only upon the GT operating parameters to model the temporary sensors during the normal operation of the turbine. As a result, the second ANN does not include any information about the health of the compressor, and consequently, the second ANN models only nominal operation of the GT. In this respect, the second ANN captures the dynamics and the variations of the temporary sensors during nominal operating conditions of the GT. It is this second ANN that represents the nominal behavior of the compressor.

Following formation of both of the ANNs, according to various embodiments of the invention, the process can further include predicting a probability of an impending compressor malfunction using the compared outputs of the two ANNs. This can include developing a stochastic decision engine to calculate the probability of a compressor rub occurrence, based on the discrepancy between outputs of the first ANN and the second ANN. In one example, the distribution of variation in outputs between the first ANN and second ANN could be assumed to fall within a particular range of one another. As the distribution variations begin to diverge, e.g., based on the rate and magnitude of divergence, the decision engine determines one or more of a probability, location, type and severity of an impending compressor malfunction. In some aspects, where the decision engine determines an impending compressor malfunction exists, the process can include modifying a mode of the compressor to protect the compressor from the impending malfunction.

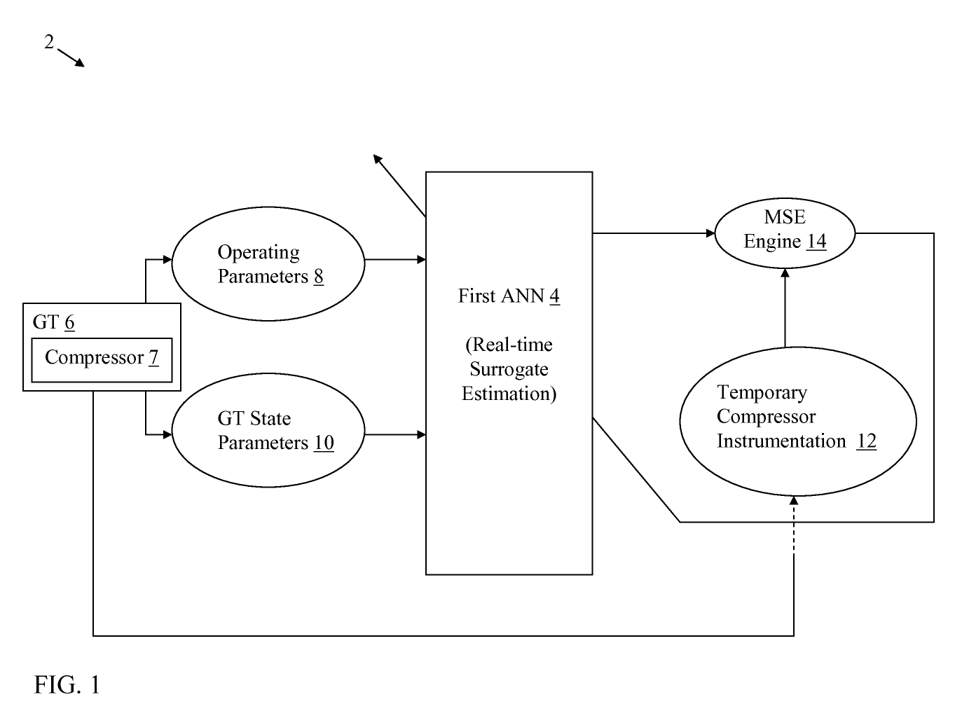

Turning to FIG. 1, a data flow diagram 2 illustrating processes in training an artificial neural network (ANN) according to embodiments of the invention is shown. More particularly, the data flow diagram 2 illustrates processes used in constructing a first ANN according to embodiments of the invention. As shown, the first ANN 4 is preliminarily developed using data about a gas turbine (GT) 6 (including data about a compressor 7 within the gas turbine 6). More particularly, the first ANN 4 is preliminarily developed by obtaining a set of operating parameters (data) 8 for the gas turbine (GT) 6 and obtaining a set of GT state parameters (data) 10. The set of GT operating parameters 8 can be represented using existing (e.g., conventional) sensors which monitor at least one of the following physical conditions of the compressor 7: inlet guide vane position, inlet bleed heat valve position, extraction flow valve position, GT shaft speed, fuel flow parameters, steam turbine state, line breaker switch, ambient conditions (e.g., temperature, pressure, humidity, etc.), etc. The set of GT state parameters 10 can be represented using existing (conventional) sensors such as: compressor discharge temperature sensors, compressor discharge pressure sensors, vibration measurements, casing door/open detectors, firing temperature sensors, flame detection sensors, estimated combustion reference temperature sensors, exhaust temperature sensors, or any other additional system model outputs. After obtaining the GT operating parameters 8 and GT state parameters 10, the process can include training the (preliminary) first ANN 4 using data obtained from a plurality of temporary sensors (temporary compressor instrumentation) 12. These temporary sensors 12 can be applied to the compressor 7 in any non-permanent manner, and can include sensors such as conventional compressor casing thermocouples, compressor casing surface strain gauges, vibration sensors, compressor blade-to-casing proximity sensors, additional exhaust temperature sensors, compressor discharge pressure/temperature sensors, shaft speed sensors and inter-stage pressure dynamic sensors. These temporary sensors 12 can be physically applied to the compressor 7, e.g., by a user such as a human operator and/or an apparatus such as a robotic apparatus. As shown in FIG. 1, the modeled output from these temporary sensors 12 and a modeled output from the preliminary first ANN 4 are both provided to a mean-squared-error (MSE) engine 14, which determines a mean squared error for each of the modeled outputs. The MSE engine 14 further compares the MSE for the modeled output from the temporary sensors 12 and the MSE for the modeled output of the (preliminary) first ANN 4 to determine whether both MSEs are within a predetermined threshold. The (preliminary) first ANN 4 can be iteratively trained to develop a final first ANN 4 by iteratively modifying the model within the first ANN 4 until the MSEs are within the predetermined threshold. After the first ANN 4 meets the MSE engine 14 requirements, the output of the first ANN 4 can act as a model of the temporary sensors on the compressor 7, where these temporary sensors can be used as real-time surrogates of parameters indicating a fault in the compressor 7 (e.g., a compressor rub). It is understood that the functions of the MSE engine 14 described herein can be implemented, alternatively, by any conventional data processing system employing e.g., an artificial intelligence, a decision engine, fuzzy logic, an expert system, etc.

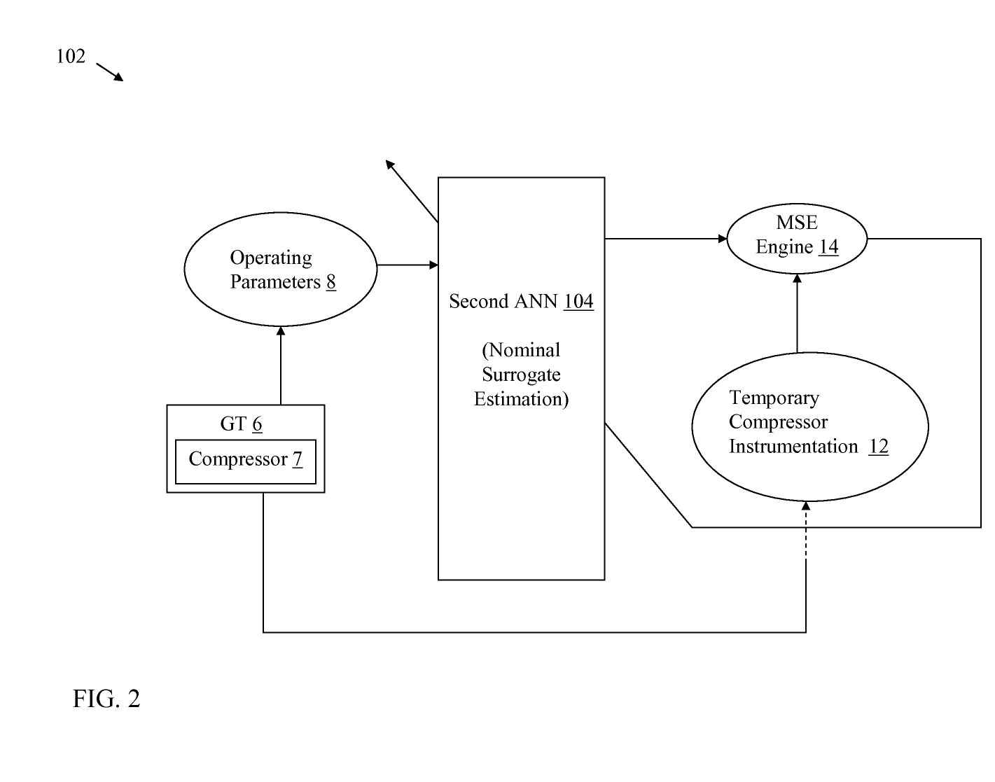

Turning to FIG. 2, a data flow diagram 102 illustrating processes in forming a second artificial neural network (ANN) 104 according to embodiments of the invention is shown. As shown, the second ANN 104 is preliminarily developed using data about the gas turbine (GT) 6 (including data about a compressor 7 within the gas turbine 6). More particularly, the second ANN 104 is preliminarily developed by obtaining a set of operating parameters (data) 8 for the gas turbine (GT) 6. As similarly described with respect to the first ANN 4 (FIG. 1), the set of GT operating parameters 8 can be represented using existing (e.g., conventional) sensors which monitor at least one of the following physical conditions of the compressor 7: inlet guide vane position, inlet bleed heat valve position, extraction flow valve position, ambient conditions (e.g., temperature, pressure, humidity, scheduled shaft speed, etc.), etc. As with the first ANN 4, the second ANN 104 can be iteratively trained by comparing the modeled output of the second ANN 104 with a modeled output of the temporary sensors 12. However, in contrast to the first ANN 4, the second ANN 104 can be developed without the use of GT state parameters 10, and instead, is developed using only the set of GT operating parameters 8. As noted, the second ANN 104 does not include data about the state of the GT 6 (and compressor 7), and as such, the second ANN 104 is used to model nominal operation of the GT 6 (and compressor 7).

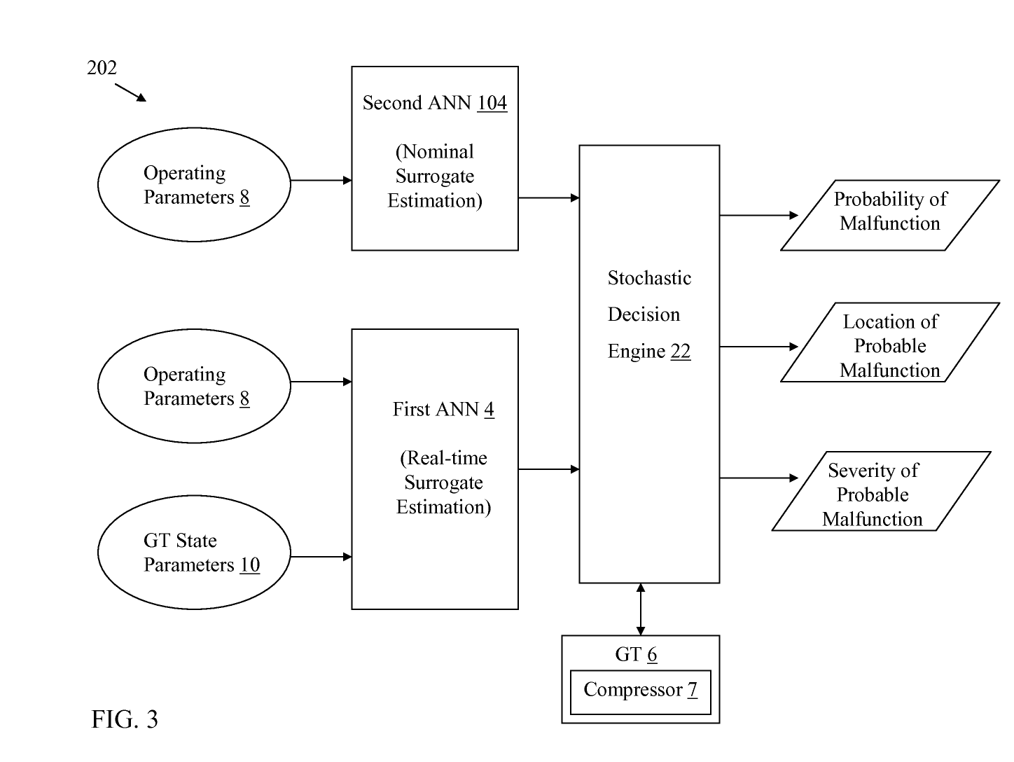

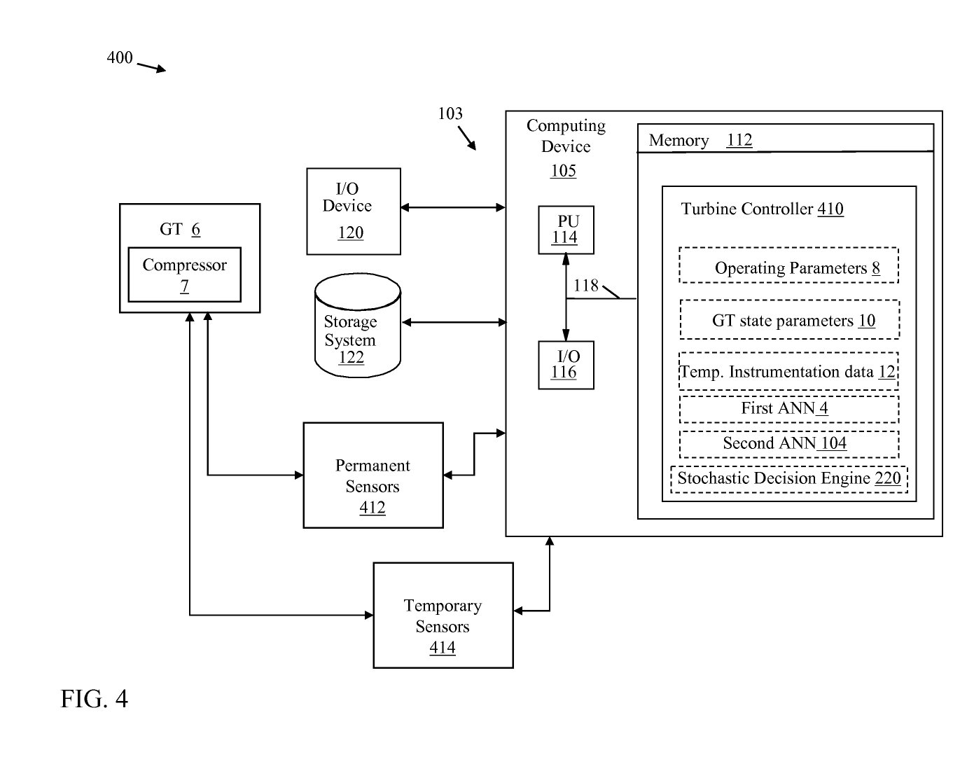

FIG. 3 is a data flow diagram 202 illustrating processes performed by a stochastic decision engine according to embodiments of the invention. As shown, a stochastic decision engine 220 can be used to determine the probability of a compressor malfunction (e.g., malfunction of compressor 7) based upon the outputs of the first ANN 4 and the second ANN 104. It is understood that the stochastic decision engine 220 can use the outputs from the first ANN 4 (real-time model of compressor operation) and the second ANN 104 (nominal operation model) after those artificial neural networks have been trained (e.g., to meet MSE engine 14 requirements). The stochastic decision engine 220 compares the modeled outputs of the first ANN 4 and the second ANN 104 to determine the probability of a fault in the GT 6 (including compressor 7). In some cases, the stochastic decision engine 220 compares the modeled outputs of the first ANN 4 and the second ANN 104 to determine a discrepancy between the outputs, and compares that discrepancy to a predetermined threshold discrepancy. In the case that the two modeled outputs vary by a value greater than the threshold, a malfunction may be indicated. It is understood that this threshold discrepancy could be a range, and could have an acceptable probabilistic-based deviation. The stochastic decision engine 220 is also capable of determining a probability of the malfunction, a location of the probable malfunction, and/or a severity of the probable malfunction. In some cases, the stochastic decision engine 220 can provide this information to a user (e.g., via a user interface as described with reference to FIG. 4).

In particular embodiments, the stochastic decision engine 220 can perform the following in order to determine a probability of the malfunction, a location of the probable malfunction and/or a severity of the probable malfunction:

Process A: Collect stochastic data such as standard deviation, mean, range of operation and distribution from the nominal/expected temporary sensor outputs;

Process B: Determine a range/threshold for each of the stochastic parameters (e.g., the threshold for standard deviation could be based on a predetermined Gaussian distribution envelope);

Process C: Analyze the stochastic data and determine a weighted severity parameter which indicates a margin exceeding the range/threshold value from Process B; and

Process D: Analyze the combination of severity parameters to determine the probability of impending failure, allowing for protective action.

In some cases, the stochastic decision engine 220 is configured to provide instructions to the GT 6 (and compressor 7) for modifying an operating parameter (e.g., an output) of the compressor 7 in response to determining the calculated probability of the malfunction exceeds a predetermined threshold. In various embodiments, the stochastic decision engine 220 continuously evaluates the outputs from the first ANN 4 and the second ANN 104 to monitor potential malfunctions in the GT 6 (and compressor 7).

As will be appreciated by one skilled in the art, the stochastic decision engine 220, first ANN 4 and/or second ANN 104 described herein may be embodied as a system(s), method(s) or computer program product(s), e.g., as part of one or more turbine controller(s). Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Magik, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described herein with reference to data flow illustrations and/or block diagrams of methods, apparatus (systems) and computer program products according to embodiments of the invention. It will be understood that each block of the data flow illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Turning to FIG. 4, an illustrative environment 400 including a turbine controller (e.g., a GT controller) 410 is shown according to embodiments of the invention. Environment 400 includes a computer infrastructure 103 that can perform the various processes described herein. In particular, computer infrastructure 103 is shown including a computing device 105 that comprises the turbine controller 22, which enables computing device 104 to implement the functions described herein. It is understood that the turbine controller 410 shown and described herein may take the form of a strictly hardware component, a strictly software component, or a combination of hardware and software components. In some cases, the turbine controller 410 can include a microprocessor and a memory, however, many configurations are possible to achieve the functions described herein.

Computing device 105 is shown including a memory 112, a processor (PU) 114, an input/output (I/O) interface 116, and a bus 118. Further, computing device 104 is shown in communication with an external I/O device/resource 120 and a storage system 122. As is known in the art, in general, processor 114 executes computer program code, such as turbine controller 410, which is stored in memory 112 and/or storage system 122. While executing computer program code, processor 114 can read and/or write data, such as operating parameters 8, GT state parameters 10, and/or temporary compressor instrumentation data 12 to/from memory 112, storage system 122, and/or I/O interface 116. Bus 118 provides a communications link between each of the components in computing device 104. I/O device 120 can comprise any device that enables a user to interact with computing device 104 or any device that enables computing device 104 to communicate with one or more other computing devices. Input/output devices (including but not limited to keyboards, displays, pointing devices, etc.) can be coupled to the system either directly or through intervening I/O controllers.

In some embodiments, as shown in FIG. 4, environment 400 may optionally include GT 6 (including compressor 7), permanent sensors 412 and/or temporary sensors 414, each of which may be operably connected (e.g., via wireless or hard-wired means) to the turbine controller 410 through computing device 105. In some embodiments, these components may be linked with one another (e.g., via wireless or hard-wired means). It is understood that turbine controller 410 may include conventional transmitters and receivers for transmitting and receiving, respectively, data from the GT 6, permanent sensors 412 and/or temporary sensors 414.

In any event, computing device 105 can comprise any general purpose computing article of manufacture capable of executing computer program code installed by a user (e.g., a personal computer, server, handheld device, etc.). However, it is understood that computing device 104 and turbine controller 410 are only representative of various possible equivalent computing devices that may perform the various process steps of the disclosure. To this extent, in other embodiments, computing device 105 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 103 is only illustrative of various types of computer infrastructures for implementing the disclosure. For example, in one embodiment, computer infrastructure 103 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

As previously mentioned and discussed further below, turbine controller 410 (including stochastic decision engine 220, first ANN 4 and second ANN 104) has the technical effect of enabling computing infrastructure 103 to perform, among other things, monitoring of a turbine (e.g., gas turbine 6 including compressor 7). It is understood that some of the various components shown in FIG. 2 can be implemented independently, combined, and/or stored in memory for one or more separate computing devices that are included in computer infrastructure 103. Further, it is understood that some of the components and/or functionality may not be implemented, or additional schemas and/or functionality may be included as part of environment 100.

The data flow diagram and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As discussed herein, various systems and components are described as “obtaining” data. It is understood that the corresponding data can be obtained using any solution. For example, the corresponding system/component can generate and/or be used to generate the data, retrieve the data from one or more data stores or sensors (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It is further understood that the terms “front” and “back” are not intended to be limiting and are intended to be interchangeable where appropriate.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system comprising:
at least one computing device configured to monitor a turbine compressor by performing actions including:
comparing a monitoring output from a first artificial neural network (ANN) about the turbine compressor to a monitoring output from a second, distinct ANN about the turbine compressor; and
predicting a probability of a malfunction in the turbine compressor based upon the comparison of the monitoring outputs from the first ANN and the second, distinct ANN.

2. The system of claim 1, wherein the at least one computing device is further configured to provide instructions for modifying an operating parameter of the turbine compressor in response to determining the predicted probability of the malfunction exceeds a predetermined threshold.

3. The system of claim 1, wherein the at least one computing device is further configured to construct the first ANN based upon both operating parameters of the turbine compressor and turbine state parameters.

4. The system of claim 3, wherein the at least one computing device is further configured to construct the second ANN based upon only the operating parameters of the turbine compressor.

5. The system of claim 3, wherein the constructing of the first ANN includes:
obtaining data about a gas turbine (GT) state and GT operating parameters to develop a preliminary first ANN; and
training the preliminary first ANN using data obtained from a plurality of temporary sensors on the turbine compressor and the data about the GT state and the GT operating parameters to develop the first ANN.

6. The system of claim 5, wherein the training further includes iteratively training the preliminary ANN until a mean squared error (MSE) of a modeled output from the preliminary ANN and an MSE of an output of the temporary sensors are within a predetermined threshold.

7. The system of claim 1, wherein the at least one computing device includes a stochastic decision engine for predicting the probability of the malfunction based on a discrepancy between the outputs of the first ANN and the second, distinct ANN.

8. A computer program comprising program code embodied in at least one computer-readable storage medium, which when executed, enables a computer system to monitor a turbine compressor by performing actions including:
comparing a monitoring output from a first artificial neural network (ANN) about the turbine compressor to a monitoring output from a second, distinct ANN about the turbine compressor; and
predicting a probability of a malfunction in the turbine compressor based upon the comparison of the monitoring outputs from the first ANN and the second, distinct ANN.

9. The computer program of claim 8, wherein the computer program further enables the computer system to provide instructions for modifying an operating parameter of the turbine compressor in response to determining the calculated probability of the malfunction exceeds a predetermined threshold.

10. The computer program of claim 8, wherein the computer program further enables the computer system to construct the first ANN based upon both operating parameters of the turbine compressor and turbine state parameters.

11. The computer program of claim 10, wherein the computer program further enables the computer system to construct the second ANN based upon only the operating parameters of the turbine compressor.

12. The computer program of claim 10, wherein the constructing of the first ANN includes:
obtaining data about a gas turbine (GT) state and GT operating parameters to develop a preliminary first ANN; and
training the preliminary first ANN using data obtained from a plurality of temporary sensors on the turbine compressor and the data about the GT state and the GT operating parameters to develop the first ANN.

13. The computer program of claim 12, wherein the training further includes iteratively refining the preliminary ANN until a mean squared error (MSE) of a modeled output from the preliminary ANN and an MSE of an output of the temporary sensors are within a predetermined threshold.

14. The computer program of claim 8, wherein the computer program further enables the computer system to deploy a stochastic decision engine for determining the probability of the malfunction based on a discrepancy between the outputs of the first ANN and the second, distinct ANN.

15. A system comprising:
a control system for a turbine compressor; and
at least one computing device operably connected to the control system, the at least one computing device configured to monitor the turbine compressor by performing actions including:
comparing a monitoring output from a first artificial neural network (ANN) about the turbine compressor to a monitoring output from a second, distinct ANN about the turbine compressor; and
predicting a probability of a malfunction in the turbine compressor based upon the comparison of the monitoring outputs from the first ANN and the second, distinct ANN.

16. The system of claim 15, wherein the at least one computing device is further configured to provide instructions to the control system for modifying an operating parameter of the turbine compressor in response to determining the calculated probability of the malfunction exceeds a predetermined threshold.

17. The system of claim 15, wherein the at least one computing device is further configured to construct the first ANN based upon both operating parameters of the turbine compressor and turbine state parameters.

18. The system of claim 17, wherein the at least one computing device is further configured to construct the second ANN based upon only the operating parameters of the turbine compressor.

19. The system of claim 17, wherein the constructing of the first ANN includes:
obtaining data about a gas turbine (GT) state and GT operating parameters to develop a preliminary first ANN; and
training the preliminary first ANN using data obtained from a plurality of temporary sensors on the turbine compressor and the data about the GT state and the GT operating parameters to develop the first ANN.

20. The system of claim 15, wherein the at least one computing device further includes a stochastic decision engine for determining the probability of the malfunction based on a discrepancy between the outputs of the first ANN and the second, distinct ANN.
